(19) United States
(12) Patent Application Publication
(10) Pub. No.: US 2007/0289543 A1
(43) Pub. Date: Dec. 20, 2007

(54) Clumping Animal Litter

(75) Inventors: Kimberly Petska, San Francisco, CA (US); Charles Fritter, Dublin, CA (US); Bradley Kirsch, Pleasanton, CA (US); Marc Privitera, Walnut Creek, CA (US); Roger V. Lee, San Ramon, CA (US); Christina M. Borgese, San Ramon, CA (US)

Correspondence Address: THE CLOROX COMPANY, P.O. BOX 24305, OAKLAND, CA, 94623-1305, US

(73) Assignee: The Clorox Company, Oakland, CA (US)

(21) Appl. No.: 11/745,163

(22) Filed: May 7, 2007

Related U.S. Application Data
(60) Provisional application No. 60/805,007, filed on Jun. 16, 2006.

(51) Int. Cl. A01K 29/00

(52) U.S. Cl. 119/173

(57) ABSTRACT

Clumping animal litters containing composite particles with increased absorptivity and clump strength are disclosed. Reinforcing fiber materials are combined with a liquid-absorbing material to form composite particles suitable for use as animal litter. The reinforcing fiber materials add structural integrity to the liquid absorbent materials by acting in a manner similar to reinforcing bars (i.e., rebar) in concrete. The fibers need only be present in small percentages to show a consumer noticeable benefit.

### RELATED APPLICATION

This application claims priority to U.S. Provisional Application No. 60/805,007, filed on Jun. 16, 2006.

### FIELD OF THE INVENTION

This invention relates generally to clumping animal litter, and, more specifically, to clumping animal litter containing reinforcing fibers.

The invention is directed generally to the addition of reinforcing fibers to animal litter and, more specifically, to the addition of reinforcing fibers to individual composite particles of absorbent animal litter materials and methods of forming the same.

### DESCRIPTION OF THE RELATED ART

Because of the growing number of domestic animals used as household pets, there is a need for litters so that animals may void, or otherwise eliminate liquid or solid waste indoors in a controlled location. However, waste buildup eventually leads to malodor production. In order to reduce or eliminate these odors, pet owners may periodically remove soiled material from the litter. The physical removal of the fecal matter does not eliminate all odors since bacteria can decompose urine that is left behind and produce foul odors. Litters have subsequently been developed that allow the user to scoop portions of litter that have absorbed the urine, thus removing one of the primary sources of odor. However, clumping litters that break, disintegrate, create dust, or crumble, are consumer dissatisfiers.

Clumping aids and other litter additives primarily geared towards improving odor control, have been disclosed. Although it is desired that these additives enhance the animal litter, they have a number of drawbacks including, stickiness, segregation, dust, density, and costliness.

Accordingly, there is a need for improved processes and materials for adding additional benefits to animal litter materials such as increased odor control without introducing the aforementioned drawbacks.

### SUMMARY OF THE INVENTION

In accordance with one aspect of the present invention a clumping animal litter comprising a plurality of composite particles is provided. Each composite particle contains a percentage of an absorbent material suitable for use as an animal litter and a percentage of a reinforcing fiber material. Optionally, a clumping agent may be added dependent upon the absorbent material chosen.

Exemplary fibers include natural materials, e.g., wool, cotton, hemp, rayon, paper, paper fluff, cellulose (including hardwood fibers, softwood fibers, processed pulp fibers, rice straw fibers, corn stover fibers, gyouli stick fibers, wheat straw fibers, starch fibers including various modified and extracted starch fibers), carbon, avian feathers, activated carbon and synthetic materials, e.g., polyester, nylon, plastics, polymers, copolymers, polypropylene, polyethylene, sodium polyacrylate, polyvinyl acetate. Combination fibers such as SAP (super absorbent polymer)/pulp fiber (about 400 μm) or SAP charged non-woven fibers can also be incorporated into the composite particles.

Reinforcing fiber attributes include the size, shape and activity of the fibers. Examples of fibers having beneficial shapes include bicomponent sheath core, bicomponent side by side, crimped fibers, bicomponent islands in the sea fibers. Examples of bicomponent fibers include fibers made of both polyethylene and polyester, or polyethylene and polypropylene. Nanofibers (i.e., fibers having at least one dimension in the nanometer size range) include those made through electrospinning techniques and bicomponent spitting techniques. Examples of active fibers include those with antimicrobial efficacy, water absorbing or (mass binding) and absorption rate efficacy, fragrance control release efficacy, and odor absorbing efficacy.

In accordance with a further aspect of the present invention a clumping animal litter comprising a plurality of composite particles is provided. Each composite particle contains a percentage of an absorbent material suitable for use as a clumping animal litter, a percentage of reinforcing fiber material and a percentage of performance-enhancing active. Exemplary actives include antimicrobials, odor absorbers/inhibitors, light-weighting agents, binders (liquid/solid, silicate, ligninsulfonate, etc.), fragrances, health indicating materials, nonstick release agents, clumping agents, low cost filler material and combinations thereof.

In accordance with another aspect of the present invention a method of forming a plurality of composite particles suitable for use as an animal litter is provided. An agglomeration process is employed to form a plurality of composite particles such that each composite particle contains a percentage of an absorbent material suitable for use as an animal litter, a percentage of a reinforcing fiber material and optionally a percentage of a performance-enhancing active. Additionally the method can further comprise the step of screening the composite particles to a specific particle size range.

Further features and advantages of the present invention will become apparent to those of ordinary skill in the art in view of the detailed description of preferred embodiments below, when considered together with the claims.

### BRIEF DESCRIPTION OF THE DRAWINGS

FIG. 1 is a plot of the values listed in Table IV.

FIG. 2 is a photograph (18× magnification) of an agglomerated composite particle containing sodium bentonite clay and 15% paper fluff fiber.

FIG. 3 is an illustration of composite particle having a core.

FIGS. 4a and 4b are illustrations of composite particles.

### DETAILED DESCRIPTION

Before describing the present invention in detail, it is to be understood that this invention is not limited to particularly exemplified systems or process parameters as such may, of course, vary. It is also to be understood that the terminology used herein is for the purpose of describing particular embodiments of the invention and is not intended to limit the scope of the invention.

All publications, patents and patent applications cited herein, whether supra or infra, are hereby incorporated by reference in their entirety to the same extent as if each individual publication, patent or patent application was specifically and individually indicated to be incorporated by reference.

It must be noted that, as used in this specification and the appended claims, the singular forms “a,” “an” and “the” include plural referents unless the content clearly dictates otherwise. Thus, for example, reference to an “odor controlling agent” includes two or more such agents.

Unless defined otherwise, all technical and scientific terms used herein have the same meaning as commonly understood by one of ordinary skill in the art to which the invention pertains. Although a number of methods and materials similar or equivalent to those described herein can be used in the practice of the present invention, the preferred materials and methods are described herein.

All numbers expressing quantities of ingredients, constituents, reaction conditions, and so forth used in the specification and claims are to be understood as being modified in all instances by the term “about”. Notwithstanding that the numerical ranges and parameters setting forth the broad scope of the subject matter presented herein are approximations, the numerical values set forth in the specific examples are reported as precisely as possible. All numerical values, however, inherently contain certain errors necessarily resulting from the standard deviation found in their respective testing measurements.

### Definitions

As is generally accepted by those of ordinary skill in the animal litter art, the following terms have the following meanings.

As used herein particle size refers to sieve screen analysis by standard ASTM methodology (ASTM method D6913-04e1).

As used herein, the terms “scoopable” and “clumping litter” refer to a litter that agglomerates upon wetting such that the soiled portion can be removed from the litter box leaving the unsoiled portion available for reuse.

The terms “non-clumping” or “poorly clumping” as used herein refers to a litter material that doesn't agglomerate upon wetting to the extent that the soiled portion could be easily removed from the litter box. As will be discussed in further detail below, additives may be added to a non-clumping or poorly clumping litter substrate to create clumping behavior that is satisfactory to the end user.

As used herein the term “composite particle” means a particle formed by combining smaller discrete particles of either the same composition or different compositions such that the resulting particle, i.e., the “composite particle”, is a particle having structural integrity that is of a particle size bigger than that of its component parts. The composite particles useful for animal litter can range in particle size between about 150 μm and about 5 mm and are typically between about 350 μm and about 3 mm.

As used herein the term “composite blend” refers to a dry mixing of the composite particles of the present invention and one or more additional absorbent litter materials and/or other litter additives or the dry mixing of composite particles having different compositions, and/or combinations thereof.

As used herein the terms “litter additives” or “other materials suitable for use as litter additives” refer to performance-enhancing actives as described herein as well as other additives known to be used in litter compositions by those having ordinary skill in the art.

As used herein the term “absorbent material suitable for use as an animal litter” refers to the many liquid-absorbing materials and combinations thereof disclosed herein as well as any other liquid-absorbing materials or combinations thereof known to those having ordinary skill in the art. The absorbent particles may range in particle size from about 150 μm to about 5 mm (4-100 mesh). Absorbent particles are typically in the size range of about 1 nm to about 5 mm prior to agglomeration, but could be up to 6 inches depending on whether the process used first breaks down the material into a smaller size prior to forming composite particles.

As used herein the term “absorbent material suitable for use as a clumping animal litter” refers to a liquid-absorbing material having an inherent ability to clump (i.e., form an agglomerate, such as sodium bentonite) when wetted or to a liquid-absorbing material having little to no inherent ability to clump that has been combined with a clumping agent.

As used herein the term “clumping agent” refers to additives, such as starch or sugar based binders that can be added to inherently non-clumping or poorly-clumping absorbent materials to create a litter material that behaves like a clumping absorbent material (i.e., upon contact with liquid, readily agglomerates with other moistened clay particles). For example, U.S. Pat. No. 5,359,961 discloses a clumping, non-swelling clay based litter and is hereby incorporated by reference in its entirety. Clumping agents as used herein are one form of performance-enhancing active.

As used herein the term “aspect ratio” when referring to a litter clump means the square root of (the square of the longest clump length plus the square of the shortest clump length) divided by the clump height. The term “aspect ratio” when referring to the reinforcing fiber materials means the length of the fiber divided by the width of the fiber.

As used herein the term “reinforcing fiber material(s)” (hereinafter “fiber(s)”) means any solid material having a mean cylindrical shape and a length to diameter aspect ratio greater than one that helps to maintain the structural integrity of litter clumps once formed. The fibers may range in particle size from about 1 nm to about 5 mm. The fibers are typically in the size range of about 1 nm to about 5 mm prior to agglomeration, but could be up to 6 inches depending on whether the process used first breaks down the material into a smaller size prior to forming composite particles. The fibers may comprise between 0.1 and 50% of the composite particle, but typically are present in an amount less than 20% (i.e., 19% or less).

The fibers may be incorporated in the composite particles in a variety of configurations such as in a layer on the surface of a particle, evenly (homogeneously) throughout the particle, in a concentric layer(s) throughout the particle and/or around a core, in pockets or pores in and/or around a particle, in a particle with single or multiple cores. A plurality of composite particles in any combination of the above configurations may be combined to form a litter material. Processes and embodiments describing the incorporation of performance-enhancing actives into a composite absorbent particle that are described in pending U.S. patent application Ser. No. 10/618,401 filed Jul. 11, 2003, which is hereby incorporated by reference in its entirety, can be employed for the incorporation of fibers into the composite particle of the present invention.

As used herein the term “performance-enhancing active” refers to a material that when present causes the litter composition to exhibit specific characteristics including but not limited to improved odor control, lower density (light-weighting agents), easier scooping, better particle/active consistency, higher clump strength, lower cost, etc. Illustrative materials for the performance-enhancing active(s) include but are not limited to antimicrobials, odor absorbers, odor inhibitors, binders, fragrances, health indicating materials, nonstick release agents, superabsorbent materials, light-weighting minerals, filler materials and combinations thereof. Performance-enhancing actives may comprise between 0-50% of the litter composition. In some cases where the performance-enhancing active is a particularly strong substance, it may be present in only about 0.001%

As used herein the term “activated carbon” means absorbent carbon-based materials, including activated and reactivated carbon-based absorbents. Activated carbon, including the material commonly called activated charcoal, is an amorphous form of carbon characterized by high adsorptivity for many gases, vapors and colloidal solids. Carbon is generally obtained by the destructive distillation of coal, wood, nut-shells, animal bones or other carbonaceous materials, including coconuts. The carbon is typically “activated” or reactivated by heating to about 800-900° C., with steam or carbon dioxide, which results in a porous internal structure. The internal surfaces of activated carbon typically average about 10,000 square feet per gram. Surface area in absorptive carbons is typically measured by a test called BET-Nitrogen, and measures the extent of the pore surfaces within the matrix of the activated carbon. BET-Nitrogen is used as a primary indicator of the activity level of the carbon, based on the principle that the greater the surface area, the higher the number of adsorptive sites available. It is believed that carbons having a BET number greater than 500 will provide odor control equivalent to PAC at concentration levels equal to or less than those disclosed herein as effective for PAC.

As used herein the term “filler materials” refer to materials that can be used as the absorbent material, but are generally ineffective at liquid absorption if used alone. Therefore these materials are generally used in combination with other absorbent materials to reduce the cost of the final litter product. Illustrative examples of filler materials include limestone, sand, calcite, dolomite, recycled waste materials, zeolites, and gypsum.

The following description includes embodiments presently contemplated for carrying out the present invention. This description is made for the purpose of illustrating the general principles of the present invention and is not meant to limit the inventive concepts claimed herein.

The present invention relates generally to composite particles with improved physical and chemical properties. The composite particles of the present invention comprise an absorbent material suitable for use as an animal litter, a reinforcing fiber material and optionally a performance-enhancing active. One of the many benefits of this technology is that the composite particles of the present invention can exhibit the beneficial properties of one or more performance-enhancing actives while surprisingly retaining the clump strength and absorption properties of the underlying absorbent material.

Methods for creating the composite particles of absorbent material, fibers and optional performance-enhancing active disclosed herein include, without limitation, a pan agglomeration process, a high shear agglomeration process, a low shear agglomeration process, a high pressure agglomeration process, a low pressure agglomeration process, a rotary drum agglomeration process, a rotary drum agglomeration process having an O'Brien Cage installed, a mix muller process, a roll press compaction process, a pin mixer process, a batch tumble blending mixer process, an extrusion process and fluid bed processes. All of these are within the definition of “agglomeration” according to the invention. Suitable agglomeration techniques are discussed in pending U.S. patent application Ser. No. 10/618,401 filed Jul. 11, 2003 and Ser. No. 11/119204 filed Apr. 29, 2005, which are hereby incorporated by reference in their entirety.

The term “non-compaction” agglomeration process refers to agglomeration that takes place under ambient or substantially ambient conditions. Examples of non-compaction agglomeration processes include a pan agglomeration process, a rotary drum agglomeration process, a rotary drum agglomeration process having an O'Brien Cage installed, a mix muller process, a pin mixer process, a batch tumble blending mixer process, and fluid bed processes.

Composite particles prepared using a non-compaction agglomeration process show a reduction in bulk density of at least about 10%. This reduction is attributed simply to the agglomeration process itself. For example, the bulk density of raw sodium bentonite is approximately 64-67 lb/ft³. The reduction in bulk density of sodium bentonite agglomerated using a pan agglomerator, a pin mixer or a rotary drum agglomeration process (including a rotary drum agglomeration process having an O'Brien Cage installed) ranges from about 8-17% (i.e., approximately 53-61 lb/ft³). It has been observed that pores, cavities and/or air pockets are created in each composite particle that is created through the use of the non-compaction agglomeration process.

One great advantage of the animal litter of the present invention is that a variety of performance-enhancing actives can be added without sacrificing the clump strength or absorptive ability of the resulting litter composition. One reason for this benefit is that composite particles are made such that substantially every composite particle contains fibers, or in the case of a composite blend, the fibers are substantially distributed throughout the litter composition. The composite particles can be dry mixed with other types of particles, including but not limited to other types of composite particles, extruded particles, particles formed by crushing a source material, etc. Mixing composite particles with other types of particles provides the benefits provided by the composite particles while allowing use of lower cost materials, such as crushed or extruded bentonite. Illustrative ratios of composite particles to other particles can be 75/25, 50/50, 25/75, or any other ratio desired.

The fibers can be added to the absorbent material matrix to impart a variety of benefits to the resulting composite animal litter material. For example, the addition of fibers increase the absorptivity and/or the structural integrity of the clumps formed when the material is wetted. By analogy, and without being bound by any particular theory, it is believed that the fibers behave in a manner similar to the reinforcing bars (i.e., rebar) used in a concrete matrix to form reinforced concrete.

Another theory is that fractions of the fibers actually protrude through the surface of the composite particles. These fractions may effect the chemical and/or physical interactions of the composite particles with each other. Without being bound by any particular theory, it is postulated that the fiber fractions may intertwine with each other in a manner that enhances clumping. By analogy, the intertwining of the fiber fractions at the composite particle surfaces appears to have an effect similar to that of Velcro balls.

A further observed benefit of having fibers in the composite particles is that the light-weight fiber materials actually decrease the bulk density of the final product to a degree greater than what was expected. For example, agglomerating 10% paper fluff fibers with sodium bentonite clay was found to reduce the bulk density by 57%.

Another observed benefit of having fibers in the composite particles is their effect on clump appearance. The clumps formed with composite particles containing fibers appear smoother, drier and closer in color to unwetted portions of the litter material. This attribute is important to the end user because a smoother, drier clump will be: (1) less apt to break apart during the removal process, (2) less apt to stick to the scoop, the box, or the animal; (3) more apt to lock in odors; (4) less apt to hurt paws or be tracked out of the litter box; (5) more apt to give the end user a better visual indication of when the clump is structurally ready for removal. Wet clumps tend to break apart so dry clumps that look wet do not give a good indication of readiness. In contrast, dry clumps that also appear dry, provide a visual que to the end user.

Composite particles containing fibers tend to have less attrition (the tendency to disintegrate, particularly during transport/shipment) and form more hemispherical (round in shape) waste clumps compared to composite particles without fibers. The hemispherical clumps tend to be stronger and better at encapsulating odor.

### Materials

### Absorbent

Illustrative absorbent materials suitable for use as an animal litter that have an inherent ability to clump when wetted include but are not limited to “swelling” clays such as sodium smectite, sodium montmorillonite (aka sodium bentonite or Wyoming bentonite), beidellite, and hectorite.

Absorbent materials having little to no inherent ability to clump generally require the aid of a clumping agent to form a clumping litter material. Illustrative examples include non-swelling or poorly-swelling clays such as calcium smectite, calcium montmorillonite (aka calcium bentonite or Georgia White Clay), attapulgite (aka palygorskite), sepiolite, natural zeolite, synthetic zeolite, kaolinite, tobermorite, vermiculite, halloysite, illite, and mica; absorbent rocks such as perlite, volcanic ash, expanded perlite, pumice, diatomite (aka diatomaceous earth), tuff, opaline silica, slate, marls, and fossilized plant material; natural minerals such as opal (aka amorphous silica), silica, quartz (aka sand), calcite, dolomite, gypsum, bassenite (aka plaster of Paris), aragonite, and feldspar; synthetic minerals such as dicalcium silicate and amorphous silicas (e.g., silica gel, precipitated silica, fumed silica, silica aerogel) and aluminas (e.g., amorphous alumina, activated alumina, activated bauxite, gibbsite, bauxite, boehmite, pseudoboehmite). As used herein the terms “non swelling clays” and “poorly swelling clays” are synonymous.

Other absorbent materials having little to no inherent ability to clump include straw, sawdust, wood chips, wood shavings, porous polymeric beads, shredded paper, bark, cloth, ground corn husks, cellulose, water-insoluble inorganic salts, such as calcium sulfate, and sand.

### Fibers

Preferred fibers include any solid material that demonstrates a mean cylindrical shape with a large length to diameter aspect ratio (e.g, 2 to 1 or greater) and the following two properties. First, a built tensile strength that is due to molecular orientation induced by the formation of the fiber whether natural or synthetically produced. Second, a surface morphology that creates bonding sites that allow the fiber to reinforce the overall structure of the particle. The bonding sites may be created either by allowing association with other chemical elements and structures (e.g., hydrogen bonding as present in polyester) or by a physical interlocking of surface morphologies (e.g., puzzle pieces).

Fibers may be made of materials such as, but not limited to natural materials, e.g., wool, cotton, hemp, rayon, lyocell, paper, paper fluff, cellulose, regenerated cellulose, bird feathers, carbon, activated carbon or synthetic materials, e.g., polyester, nylon, plastics, polymers (including super absorbent polymers (SAPs) and copolymers). Illustrative reinforcing fibers include paper fluff, DuPont's Kevlar® (poly-paraphenylene terephthalamide) yarn, PET (polyethylene terephthalate), Tencel® cellulose fiber, rayon, cotton, poultry feather parts, cellulose, and combinations thereof. Reclaim, i.e., a recycled mixture incorporating some or all of the synthetic materials listed above, could also be used.

Performance-enhancing actives may be embedded within the fibers or attached to the surface of the fibers to augment a specific consumer-benefiting feature, such as odor control or enhanced absorptivity or both. Cotton fibers embedded with activated carbon could be combined with an absorbent clay to form composite particles suitable for use as an animal litter having increased odor control. Non-woven fibers charged with SAPs (e.g., BASF luquafleece IS) could be combined with an absorbent clay to form composite particles having increased absorptivity. The resulting litter compositions would have the advantage of controlling odors and moisture as strong clumps are formed.

Benefits imparted by the fibers (either alone or in combination with performance-enhancing actives) may include without limitation, structural integrity, clump strength, increased liquid absorption, abrasion resistance, animal attractant/repellant, visual aesthetics, tactile aesthetics and increased odor control (e.g., activated carbon fibers). Clump strength is a measure of the mechanisms that aid in the formation of agglomerates (moist litter particles that stick together) in the litter box. Crimped fibers (helical and saw-tooth) may provide higher clumping strength or reduced attrition in processing and handling.

Bicomponent and/or multi-component fibers may provide additional benefits. For example, one component of the fiber may melt and act as an adhesive during the agglomeration drying process to further enhance the strength of the composite particles, while the other component may retain it's length/integrity in order to provide a reinforcing benefit and increase clump strength. When the fiber is subjected to the melt temp of the lower meting component, the lower melting component acts as the adhesive, while the higher melting component retains the shape and a portion of the integrity of the fiber. Some examples include fibers made of both polyethylene and polyester, or polyethylene and polypropylene in a side by side or a sheath/core configuration.

Additional attributes may be present if the fibers are porous. Fiber porosity could lead to a three-fold benefit: (1) light-weighting (i.e., a decrease in the bulk density of the litter composition), (2) increased odor and/or moisture absorption (i.e., within the pores due to an increase in surface area), and (3) encapsulation/carrier vehicle for performance-enhancing actives, such as odor absorbers, moisture absorbers, antimicrobials, fragrances, clumping agents, etc. These benefits combined with the aforementioned additional clump strength and clump integrity are unexpected. Generally lower density, higher porosity litter materials with litter additives work to decrease clump strength. This common drawback is overcome by the composite particles disclosed herein.

When only 2% paper fluff fibers are added to a primarily sodium bentonite composition via a pilot plant scale pin mixer equipped with a rotary drier, a 13% reduction in bulk density is observed.

The clump aspect ratio, which is defined as Square root ((longest clump length)²+(shortest clump length)²)/clump height may be affected by the addition of fibers to the composite particles. In general, it is desirable to have a round clump, which translates to an aspect ratio of about 0.5. Higher aspect ratios are indicative of less round, more “pancake-shaped” clumps, which may be acceptable, if other benefits are gained (e.g., an increase in liquid absorption or a decrease in clumps sticking to the box).

The fibers can range in particle size from about 1 nm to about 6 inches (typically ranging between 1 nm and 5 mm) and generally are present in 0.1-50% by weight of the composite particles. The size and shape of the fibers chosen may aid in controlling the particle size and shape of the resulting composite particles. For example, it is expected that longer fibers will yield larger agglomerate particles and a blend of fiber lengths will yield composite particles of varying particle sizes.

U.S. Pat. No. 5,705,030 assigned to the United States Department of Agriculture, which is hereby incorporated by reference in its entirety, describes a process for converting chicken feathers into fibers. According to U.S. Pat. No. 5,705,030, feathers from all avian sources have the characteristics which are necessary for the production of useful fibers, therefore feathers from any avian species may be utilized. Feathers are made up of many slender, closely arranged parallel barbs forming a vane on either side of a tapering hollow shaft. The barbs have bare barbules which in turn bare barbicels commonly ending in hooked hamuli and interlocking with the barbules of an adjacent barb to link the barbs into a continuous vane.

Structurally, chicken feather fibers have naturally-occurring nodes approximately 50 microns apart. These nodes are potential cleavage sites for producing fibers of uniform 40-50 μm lengths. In addition, feathers from different species vary in length: poultry feather fibers are approximately 2 cm in length while those derived from exotic birds such as peacocks or ostriches are 4 to 5 cm or longer. Feather fibers are also thinner than other natural fibers resulting in products having a smooth, fine surface.

The composition of wood pulp fiber is generally about 50% cellulose with the remainder being lignin and hemicelluloses. Hardwood trees have broad leaves and softwood trees have needle-like or scale-like leaves. Hardwood trees have shorter fibers compared to softwood trees. All freshly cut wood contains moisture. Wood pulp has a tendency to be at “equilibrium density”, i.e., the density at which the addition of more water does not swell or flatten the wood. If the wood pulp sheet is low density and water is added, it flattens out to equilibrium density. If the wood pulp sheet is high density, it swells to the equilibrium density.

Equilibrium density plays a significant role when agglomerated with an absorbent material suitable for use as a cat litter. While in an air stream, if the density of the wood pulp fiber is close to the density of the composite particles formed, a homogenous blend of fibers within the composite particles may be obtained. If there is a significant difference between the density of the wood pulp and the density of the composite particles formed, there is the possibility of fiber aggregation.

Wood pulp strength is directly proportional to fiber length and dictates its final use. A long fiber pulp is good to blend with short fiber pulp to optimize on fiber cost, strength and formation of paper. In general, pulp made from softwood trees or wood grown in colder climates have longer fibers compared to pulp made from hardwood trees or wood grown in warmer climates.

Processing conditions also contribute to fiber length. When made from the same wood, chemical pulps tend to have longer fibers compared to semi-chemical pulp and mechanical pulp. Examples of long fiber pulp (>10 mm) are cotton, hemp, flax and Jute. Examples of medium fiber pulp (2-10 mm) are Northern softwoods and hardwoods. Examples of short fiber pulp (<2 mm) are tropical hardwoods, straws and grasses.

Illustrative performance-enhancing actives include but are not limited to antimicrobials, odor absorbers/inhibitors, binding agents (aka clumping agents), fixing agents, fragrances, health indicating materials, nonstick release agents, super absorbent materials (e.g., super absorbent polymers), and combinations thereof. The composite particles of the present invention can be formed such that substantially every composite particle contains a percentage of performance-enhancing active. In the case of a composite blend, the performance-enhancing actives are substantially distributed throughout the resulting litter composition.

### Antimicrobial

Antimicrobials and/or urease inhibitors are performance-enhancing actives that act as odor control agents by preventing the causes of the odor, such as inhibiting the bacteria that create the odors. One class of anti-bacterial or odor control agents is water soluble transition metal ions and their soluble salts such as silver, copper, zinc, iron, and aluminum salts and mixtures thereof. Examples of metallic salts include zinc chloride, zinc gluconate, zinc lactate, zinc maleate, zinc salicylate, zinc sulfate, zinc ricinoleate, copper chloride, copper gluconate, and combinations thereof. Preferred transition metals include silver, copper, zinc, ferric and aluminum salts.

Other odor control anti-bacterial agents include sulfuric acid, phosphoric acid, hydroxamic acid, thiourea, iodophores, 3-isothiazolones, salts of phytic acid, plant extracts, pine oil, naturally occurring acids and antimicrobials, such as quaternary ammonium compounds, organic sulfur compounds, halogenated phenols, hexachlorophene, 2,4,4′-trichloro-2′-hydroxydiphenyl ether, trichiorocarbanalide, 2,4-dichloro-meta-xylenol, 3,4,5-tribromosalicylanalide, 3,5,3′,4′-tetrachlorosalicylanalide, and combinations thereof. Some of these odor control anti-bacterial agents can be added to litters to function as bacteriostats, i.e., they are present in relatively low amounts to ensure lack of or minimalodor by transiently present bacteria which may act on the unused litter ingredients to produce off-odors or signal to the consumer that the product is “not fresh.” Some of the preferred bacteriostats include a number of materials produced by Rohm and Haas under the brand name Kathon.

A particularly effective class of bacteriostats are boron compounds, including borax pentahydrate, borax decahydrate and boric acid. Polyborate, tetraboric acid, sodium metaborate and other forms of boron are also appropriate alternative materials. Other boron-based compounds potentially suitable for use are disclosed in Kirk-Othmer, Encyclopedia of Chemical Technology, 3^{rd} Ed., Vol. 4, pp. 67-109 (1978), which is incorporated by reference herein. Effective borax compounds are disclosed in U.S. Pat. No. 5,992,351, which is incorporated herein by reference in its entirety.

Applicants have found that borax provides multiple benefits in odor control by: (1) acting as a urease inhibitor, which controls odors by preventing enzymatic breakdown of urea; and (2) exhibiting bacteriostatic properties, which appear to help control odor by controlling the growth of bacteria which are responsible for production of the urease enzymes. Applicants have further found that an odor controlling effective amount comprises at least about 0.02% equivalent boron. Greater than 0.03% equivalent boron is preferred.

In some embodiments, the anti-bacterial agent comprises approximately 0.02%-1%, by weight, of the litter composition and typically the anti-bacterial agent comprises approximately 0.02%-0.15%, by weight, of the litter composition. As will be appreciated by one skilled in the art, the compositional levels can be adjusted to ensure effective odor control and cost effectiveness.

### Light Weighting

Exemplary light-weighting materials include but are not limited to perlite, expanded perlite, volcanic glassy materials having high porosities and low densities, vermiculite, expanded vermiculite, pumice, silica gels, opaline silica, tuff, and lightweight agricultural byproducts. As used herein the term “expanded perlite” is synonymous with the term “volcanic ash”. When selecting a light-weighting material, the effect the light-weighting material will have on the litter's performance is an important consideration. Factors to evaluate include how the light-weighting material will effect cost, ease of manufacture, clumping, tracking, absorbency, odor control, sticking to the box, dust, etc. Light-weighting actives can be incorporated within the composite particles of the present invention or they may be dry blended with the composite particles of the present invention. Incorporation of light-weighting actives into composite particles is extensively described in U.S. patent application Ser. No. 11/119,204 filed Apr. 29, 2005, which is hereby incorporated by reference in its entirety.

### Odor Absorber

The performance-enhancing active may be one or more odor controlling agents in the form of odor absorbing agents, such as activated carbon, which provide an odor control benefit by preventing the odors from being detected, such as absorbing, encasing, or neutralizing the odor. Compounds that absorb primary amines are particularly desirable. Other odor control actives include nanoparticles that may be composed of many different materials such as carbon, metals, metal halides or oxides, or other materials. Additional types of odor absorbing/inhibiting actives include fragrant oils, carbonates, bicarbonates, kieselguhr, chelating agents, chitin and pH buffered materials, such as carboxylic acids and the like, cyclodextrin, zeolites, silicas, acidic salt-forming materials, and mixtures thereof. Activated alumina (Al₂O₃) has been found to provide odor control comparable and even superior to other odor control additives. Alumina is a white granular material, and is properly called aluminum oxide.

Powdered Activated Carbon (PAC) and Granular Activated Carbon (GAC) are effective odor absorbing materials. PAC gives more exposed surface than GAC (e.g., ≧80 mesh U.S. Standard Sieve (U.S.S.S.)), and thus has more exposed sites with which to trap odor-causing materials and is therefore more effective. PAC will tend to segregate out of the litter during shipping, thereby creating excessive dust (also known as “sifting”). By agglomerating PAC into the composite particles of the present invention (or adding the PAC to the composite particles by a later processing step), the problems with carbon settling out during shipping is overcome. Additionally, carbon is black in color. Agglomerating the PAC (and/or GAC) into the composite particles (or adding it to the composite particles by a later processing step) aids in diluting the black color of the carbon, a factor known to be disliked by cat litter consumers. The above-mentioned benefits of incorporating carbon into the composite particles are true for composite blends, as well. Generally, the mean particle diameter of the carbon particles used is less than about 500 microns, but can be larger. One embodiment utilizes PAC having a particle size about 150 microns (˜100 mesh U.S.S.S.) or less. Another embodiment utilizes PAC having a particle size in the range of about 25 to 150 microns, with a mean diameter of about 50 microns (325 mesh U.S.S.S.) or less. Surprisingly, low levels of PAC (0.05-5%) have been found to provide excellent odor control in cat litter when they are bound to the porous surfaces of a sodium bentonite clay. However, PAC may be present in concentrations ranging from 0-50%, but typically would not be expected to exceed 20%. The incorporation of PAC into composite particles is described in previously cited U.S. patent application Ser. No. 11/119,204 filed Apr. 29, 2005.

### Fragrance

The performance-enhancing active may comprise one or more fragrances to provide a freshness or deodorizing impression to humans or serve as an attractant fragrance to animals. Although some “free” fragrance can be present, it is preferable that at least a major part of the fragrance (or perfume) be contained or encapsulated in a carrier to prevent premature loss to the atmosphere, as well as to avoid a strong fragrance odor which can be uncomfortable to the animals. The encapsulation can be in the form of molecular encapsulation, such as the inclusion complex with cyclodextrin, coacevate microencapsulation wherein the fragrance droplet is enclosed in a solid wall material, or “cellular matrix” encapsulation wherein solid particles containing perfume droplets are stably held in the cells. Incorporating the fragrance in the composite particle is one method of encapsulation. The fragrance can also be more crudely embedded in a matrix, such as a starch or sugar matrix.

The encapsulated fragrance can be released either by a moisture activation and/or a pressure activation mechanism. Moisture-activated microcapsules release fragrance upon being wetted, e.g., by the animal urine. Pressure-activated microcapsules release fragrance when the shell wall is broken, e.g., by the scratching or stepping of the animals on the litter. Some microcapsules can be activated both by moisture and pressure.

Alternatively, the fragrance can be a pro-fragrance. A pro-fragrance is a normally nonvolatile molecule which consists of a volatile fragrance ingredient covalently bonded to another moiety by a labile covalent bond. In use, the pro-fragrance is decomposed to release the volatile fragrance ingredient. Preferred pro-fragrances include complexes of bisulfite, with fragrance ingredients having aldehyde or ketone functional groups, and esters of phosphoric acids, and sulfuric acids with fragrance ingredients having a hydroxyl group.

The fragrance may comprise approximately 0.001%-1%, by weight, of the litter composition, and typically comprises approximately approximately 0.01%-0.2%, by weight, of the litter composition.

### Binding Agent

Illustrative examples of binder agents which can be incorporated in the composite particles or added to the litter composition are water, lignin sulfonate (solid), polymeric binders, fibrillated Teflon® (polytetrafluoroethylene or PTFE), and combinations thereof. Useful organic polymerizable binders include, but are not limited to, carboxymethylcellulose (CMC) and its derivatives and its metal salts, guar gum cellulose, xanthan gum, starch, lignin, polyvinyl alcohol, polyacrylic acid, styrene butadiene resins (SBR), and polystyrene acrylic acid resins and combinations thereof. Water stable particles can also be made with crosslinked polyester network, including but not limited to those resulting from the reactions of polyacrylic acid or citric acid with different polyols such as glycerin, polyvinyl alcohol, lignin, and hydroxyethylcellulose. The binding agents can function as clumping agents as described in U.S. Pat. No. 5,359,961 cited above and U.S. Patent Application Publication Number US 2004/0025798 filed Aug. 7, 2002, which is hereby incorporated by reference in its entirety.

### Fixing Agent

A fixing agent or combination of fixing agents may be used in conjunction with a binding agent to keep the binding agent adhered to the composite particles or particles in a composite blend. Fixing agents help eliminate segregation (which can decrease clump strength) during agitation such as when the litter composition is shipped from one location to another. Suitable agents include (i) natural polymers and synthetic derivatives thereof, including, but not limited to, lignins, gums, starches and polysaccharides, such as lignin sulfonate, carboxymethylcellulose, hydroxyethylcellulose, hydroxypropylcellulose, ethylhydroxyethyl cellulose, methylhydroxypropylcellulose, guar gum, alginates, starch, xanthan gum, gum acacia, and gum Arabic, (ii) synthetic polymers, including, but not limited to, polyvinylpyrrolidone, polyethylene glycol, polyethyleneoxide, acrylate polymers and copolymers, acrylic emulsions, polyvinyl alcohol, polyvinyl acetate, polyvinyl pyrrolidine, polyacrylic acid, latexes (e.g., neoprene latex), superabsorbent polymers (e.g., cross-linked polyacrylates), flocculating agents (e.g., polycarboxylates), and fluorinated polymers (e.g., polytetrafluoroethylene), fibrillated Teflon, and (iii) inorganic agglomerating agents, including, but not limited to, soluble silicates and phosphates, including pyrophosphates and aluminates. Acrylic polymers or co-polymers from Rhodia, BASF and other emulsion polymer vendors may be used.

The amount of the fixing agent present in the litter composition varies. The fixing agent is water-soluble and generally comprises up to approximately 6%, by weight, of the litter composition. Typically, the fixing agent comprises less than approximately 2%, by weight, of the litter composition.

Suitable fixing agents which also serve to control dust include, but are not limited to fluorinated polymers such as Teflon and tacky acrylic polymers such as those sold as Rhodopas® or Rhoplex®.

### Non-Stick

Suitable nonstick additives include surfactants, polymers, Teflon, starches, silicones, Georgia white clay, sand, limestone. Generally, any mineral material that does not dissolve or swell in the presence of water will act as an inert spacer between the primary absorbent material and the litter box, providing some reduction in sticking. The effect is greater when the spacer is a particle size that is finer than the primary absorbent material.

### Health Indicating

Suitable health indicating actives may also be added to the litter compositions disclosed herein. One such additive is a pH indicator that changes color when urinated upon, thereby indicating a health issue with the animal. U.S. Pat. No. 6,308,658, incorporated herein by reference in its entirety, describes a litmus agent that visually indicates the presence of a urinary infection in animals. Another additive, disclosed in U.S. patent application Ser. No. 11/140,795, filed May 31, 2005 detects the presence of protein in urine which is indicative of a health problem in the animal.

### Moisture Absorbing Polymers

Superabsorbent materials can be used as a performance-enhancing active. Suitable superabsorbent materials include superabsorbent polymers such as AN905SH, FA920SH, and FO4490SH, all from Floerger. Preferably, the superabsorbent material can absorb at least 5 times its weight of water, and ideally more than 10 times its weight of water.

### Colorant

A dye or pigment such as a dye, bleach, lightener, etc. may be added to vary the color of composite particles, such as to lighten the color of the litter composition so it is more appealing to the end user.

### Filler

Filler materials can be combined with the composite particles to reduce the cost of the animal litter composition without significantly decreasing the material's performance as a litter. Filler materials are one form of performance-enhancing active as they tend to reduce the cost of the litter composition. Illustrative filler materials include limestone, sand, calcite, dolomite, recycled waste materials, zeolites, perlite, expanded perlite, vermiculite, expanded vermiculite, diatomaceous earth, gypsum and combinations thereof. Although these materials could be included as part of the composite particles themselves, they are typically incorporated into the animal litter by dry blending with the composite particles to form a composite blend. Filler materials may comprise anywhere from 1-50% of the litter composition.

### EXAMPLES

Cellulose fibers in the form of paper fluff were obtained from FEECO, Green Bay, Wis. Sodium bentonite clay was obtained from Black Hills Bentonite, Casper, Wyo. Activated carbon was obtained from Calgon Carbon Corporation, Pittsburgh, Pa. Expanded perlite (bulk density 5 lb/ft³) was obtained from Kansas Minerals, Mancato, Kans.

Fibers were added to a sodium bentonite clay litter material to access what effect the addition of the fibers had on the litter composition's properties such as absorptivity, clump strength and odor control. The fibers were added in a manner such that a homogeneous mixture of fibers and absorbent material resulted.

Cat urine was obtained from several cats so it is not cat specific.

### Experiment 1

Cellulose fibers (2-3 mm) were added to sodium bentonite clay (about 100-500 mesh) in a pilot plant scale pin mixer equipped with a rotary drier to form composite particles. The particles were then sieve-screened to approximately 12×40 mesh and 6×40 mesh in size. The cellulose fibers were added at 0%, 4%, and 6% levels. Each sample depicted in the tables below represents six clumps. Three of the six clumps were formed by dosing the litter composition with 10 ml of cat urine and waiting 2 hours. The remaining three of the six clumps were formed by dosing the litter compositions with 10 ml of cat urine, waiting 1 hour, then redosing with an additional 10 ml of cat urine and waiting an additional 1 hour. All six clumps were then shaken lightly for 5 seconds. The clumps were pancake-shaped and sticky to the scoop and to the touch.

Table I summarizes the average size, shape and strength of the clumps.

TABLE I

| | | | | | Avg. Clump |
|---|---|---|---|---|---|
| | Avg. Longest | Avg. Shortest | Avg. Height | | Strength |
| Sample | Length (mm) | Length (mm) | (mm) | Aspect Ratio | (% retained) |
| 0% fibers (12 × 40) | 67.14 | 63.26 | 11.65 | 7.9 | 97.6% |
| 0% fibers (6 × 40) | 68.33 | 61.23 | 15.55 | 5.9 | 97.8% |
| 4% fibers (12 × 40) | 63.34 | 59.74 | 12.13 | 7.2 | 96.3% |
| 4% fibers (6 × 40) | 66.81 | 58.82 | 18.44 | 4.8 | 96.8% |
| 6% fibers (12 × 40) | 64 | 61.33 | 11.35 | 7.8 | 95.8% |
| 6% fibers (6 × 40) | 68.46 | 54.75 | 15.25 | 5.7 | 97.7% |

TABLE II

| | | | | | Avg. Clump |
|---|---|---|---|---|---|
| | Avg. Longest | Avg. Shortest | Avg. Height | | Strength |
| Sample | Length (mm) | Length (mm) | (mm) | Aspect Ratio | (% retained) |
| 0% fibers (12 × 40) single dose | 48.33 | 46.67 | 17.67 | 3.8 | 95.10% |
| 0% fibers (12 × 40) double dose | 73.33 | 64.33 | 17.67 | 5.5 | |
| 0% fibers (6 × 40) single dose | 43.67 | 43.33 | 19.33 | 3.2 | 94.40% |
| 0% fibers (6 × 40) double dose | 70.67 | 61.67 | 20 | 4.7 | |
| 4% fibers (12 × 40) single dose | 44.5 | 44 | 17 | 3.7 | 94.50% |
| 4% fibers (12 × 40) double dose | 49 | 45 | 19 | 3.5 | |
| 4% fibers (6 × 40) single dose | 46 | 44.33 | 20 | 3.2 | 94.10% |
| 4% fibers (6 × 40) double dose | 69.33 | 56 | 22 | 4.1 | |
| 6% fibers (12 × 40) single dose | 59.33 | 54.68 | 16.67 | 4.8 | 94.30% |
| 6% fibers (12 × 40) double dose | 68.33 | 67 | 16 | 6 | |
| 6% fibers (6 × 40) single dose | 54.67 | 49 | 13 | 5.6 | 94.70% |

### Experiment 2

Cellulose fibers were added to sodium bentonite clay in a pilot plant scale pin mixer equipped with a rotary drier to form composite particles. The cellulose fibers were added at 0%, 4%, and 6% levels. The composite particles were then blended with non-agglomerated bentonite clay and sieve-screened to 12×40 mesh to form a litter composition comprised of a composite blend (i.e., about 35% composite particles: about 65% bentonite clay). Each sample represents the average of three clumps formed by dosing the litter compositions with 10 ml of cat urine and waiting 2 hours (single dose) or the average of three clumps formed by dosing the litter compositions with 10 ml of cat urine, waiting 1 hour, redosing the clumps with an additional 10 ml of cat urine and waiting an additional 1 hour. Longest length, shortest length and height measurements were taken without disturbing the clumps in the box.

In addition to the clump size, the clump strength was also measured, i.e., the ability of a scoopable litter composition to form strong urine clumps which remain intact when removed from a litter box. After being measured, the clumps were allowed to sit in the box for about six hours. The clumps were then removed, placed on a wide (about ½ inch) mesh screen, shaken on a machine using lateral rotating action (about 5 lateral revolutions per second) for about 5 seconds and weighed. The clump strength is reported as Percent Retained, i.e., final weight/initial weight×100%. The higher the number, the better the clump strength. The clumps were pancake-shaped and sticky to the scoop and to the touch.

Table II summarizes the average size and shape of the clumps and the clump strength at the two different dosing levels and the three different fiber levels.

### Experiment 3

Cellulose fibers were added to sodium bentonite clay (about 100-500 mesh) and powder activated carbon (about 25-150 μm) in a pilot plant scale drum mixer equipped with a rotary drier to form composite particles. The composite particles were sieve-screened to about 4×60 mesh. The cellulose fibers were added at 0%, 5%, and 15% levels. Each sample represents three clumps formed by dosing the litter compositions with 10 ml of cat urine and waiting 2 hours (single dose) or three clumps formed by dosing the litter compositions with 10 ml of cat urine, waiting 1 hour, redosing the clumps with an additional 10 ml of cat urine and waiting an additional 1 hour. In addition to the clump size, the clump strength was also measured using the method outlined in Experiment 2 above. Absorbent capacity was calculated by determining the weight of litter needed to absorb 10 ml or cat urine. Absorbency is reported as the grams of urine absorbed per 1 gram of litter composition.

Table III summarizes the average size, shape, strength and absorbency of the three clumps at different fiber and different active levels. In addition, a comparison of cellulose fiber composite particles and expanded perlite composite particles is shown.

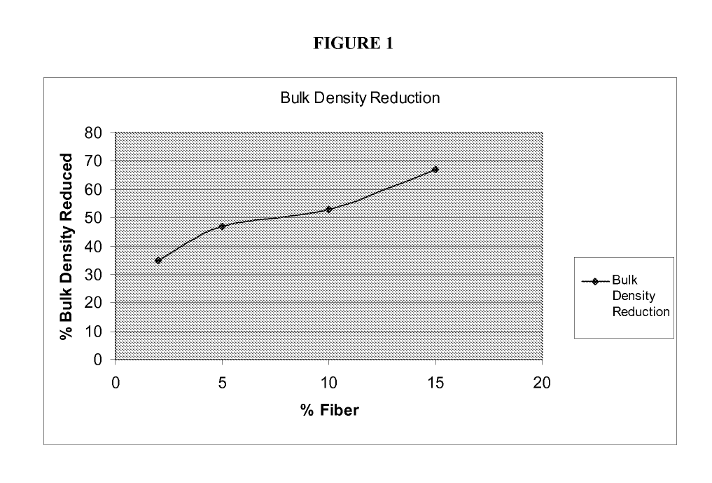

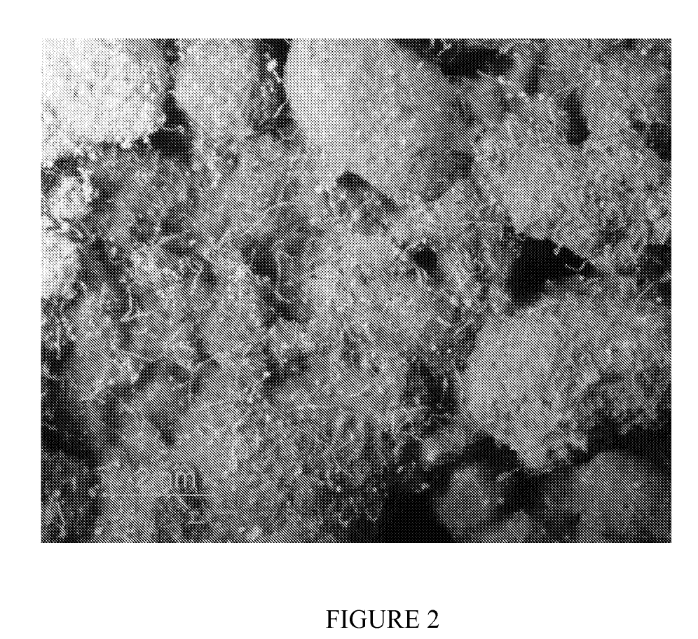

About ten percent cellulose fibers (about 2-3 mm paper fluff) were blended with about 90% bentonite (about 100-500 μm) in a drum agglomerator. The average bulk density of three different runs was calculated to be 0.46 g/cc or 28.7 lb/ft³. The average bulk density of agglomerated bentonite alone is approximately 55 lb/ft³. Thus, the addition of cellulose fibers into the composite particle provides a beneficial light-weighting effect. Table IV lists the bulk density reduction observed with the addition of 2, 5, 10 and 15 percent paper fluff fibers. FIG. 1 is a plot of the values listed in Table IV. FIG. 2 is a photograph at 18 times magnification of composite particles containing sodium bentonite and 15% paper fluff fibers.

TABLE III

| | | | | Avg. | Avg. | | | | Avg. |
|---|---|---|---|---|---|---|---|---|---|
| Sample (balance is bentonite) | | | | Longest | Shortest | | Avg. | Avg. | Clump |
| % Paper | | % Expanded | | Length | Length | Avg. Height | Aspect | Clump | Strength |
| fluff | % PAC | Perlite | Dose Type | (inches) | (inches) | (inches) | Ratio | Absorbency | (% Retained) |
| 15 | 0.5 | 0 | Single | 1.4 | 1.4 | 1.2 | 1.7 | 1.29 | 86% |
| 15 | 0.5 | 0 | Double | 1.8 | 1.9 | 1.2 | 2.2 | 1.48 | |
| 5 | 0.5 | 0 | Single | 1.6 | 1.4 | 1 | 2.1 | 0.87 | 96.40% |
| 5 | 0.5 | 0 | Double | 2.3 | 2.3 | 0.9 | 3.6 | 0.89 | |
| 0 | 0.5 | 4 | Single | 2.3 | 1.7 | 0.5 | 5.7 | 1.56 | 98.50% |
| 0 | 0.5 | 4 | Double | 2.9 | 1.8 | 0.5 | 6.8 | 1.48 | |

TABLE IV

| | Bulk | Bulk |
|---|---|---|
| % Paper | Density | Density |
| fluff fibers | (lb/ft³) | Reduction |
| 2 | 36 | 35% |
| 5 | 29 | 47% |
| 10 | 26 | 53% |
| 15 | 18 | 67% |

TABLE V

| | | Avg. | | | | | |
|---|---|---|---|---|---|---|---|
| | | Longest | Avg. Shortest | | | | Avg. Clump |
| | Dose | Length | Length | Avg. Height | Avg. Aspect | Avg. Clump | Strength |
| Sample | Type | (inches) | (inches) | (inches) | Ratio | Absorbency | (% Retained) |
| Raw bentonite | Single | 44.6 | 43.2 | 25.8 | 2.41 | 0.44 | 94.1 |
| Raw bentonite | Double | 70.5 | 54.3 | 26.6 | 3.35 | 0.44 | |
| Composite Particles, | Single | 47 | 41.3 | 21.5 | 2.91 | 0.97 | 96.7 |
| 100% bentonite | | | | | | | |
| Composite Particles, | Double | 67.8 | 55.7 | 18.9 | 4.65 | 0.9 | |
| 100% bentonite | | | | | | | |
| Composite Particles, | Single | 53.1 | 36.6 | 15.9 | 4.06 | 1.5 | 97.6 |
| 98% bentonite, | | | | | | | |
| 2% paper fluff | | | | | | | |
| Composite Particles, | Double | 65.5 | 48.5 | 16.3 | 5.01 | 1.5 | |
| 98% bentonite, | | | | | | | |
| 2% paper fluff | | | | | | | |

### Experiment 4

The absorption capacity and clumping characteristics of raw sodium bentonite, agglomerated sodium bentonite, and sodium bentonite agglomerated along with 2% paper fluff were compared. The agglomeration was performed in a pilot plant scale pin mixer and drum agglomerator equipped with a rotary drier. Composite particles as defined above were formed. Absorbency was calculated by determining the weight of litter needed to absorb 10 ml of cat urine. Absorbency is reported as the grams of urine absorbed per 1 gram of litter composition. The clumps were formed using the following method. Each sample represents three clumps formed by dosing the litter compositions with 10 ml of cat urine and waiting 2 hours (single dose) or three clumps formed by dosing the litter compositions with 10 ml of cat urine, waiting 1 hour, redosing the clumps with an additional 10 ml of cat urine and waiting an additional 1 hour (double dosed). Table V summarizes the average size, shape, strength and absorbency of the three samples.

Without being bound by any particular theory, it is believed that the clumping benefit results from the fibers in one composite particle grabbing onto the fibers in another composite particle providing a loading effect. It is believed that the absorption benefit results from the fact that wetting plus absorption occurs faster in fiber/clay composites than in clay-only composites or raw clay alone. Although paper fluff was used in the above experiments, incorporation of any one or more of the other types of fibers described herein into the bentonite composite particles is expected to result in a litter composition that exhibits similar clumping and absorption benefits. Similarly, although sodium bentonite was used in the above experiments, composite particles containing any one or more of the other types of absorbents described herein together with any one or more fibers is expected to result in a litter composition that exhibits enhanced clumping and absorption benefits.

If, for example, poultry feathers (such as from a chicken) are the reinforcing fiber material incorporated into the composite particle, the branched nature microstructure of the feathers will enhance the number and efficiency of connection bond points within the composite particle. This increase in connection bond points induces physical crosslinks and entanglements through feather-feather interdigitation that allow structural loads in the composite particle to be carried along the fiber, thus allowing strength in tension.

Samples having a bentonite to chicken feather ratio ranging from 100:0 to 50:50 were prepared and evaluated. The diameters of the fibers used were less than the mean diameter of the composite particles formed. At about 20% by weight of chicken feathers, the excess feathers began to extend from the composite particle surface. As the fiber length increased, the less the chicken feather mass was completely incorporated into the composite particles.

Poultry feathers incorporated into the composite particles described herein generally range in size from about 0.1-5 mm in length for single strand cuts and from about 0.1-5 mm in mean diameter and about 80 μm in mean length for planer cut shapes (inclusive of tendrils extending from the core, vanes and/or barbs). The average bulk density of the fibers is approximately 9 lb/ft³. Thus, in addition to absorptive and clumping benefits, poultry feathers can also add a lightweighting benefit to the resulting litter composition.

### Agglomerated litter with a Swelling Core

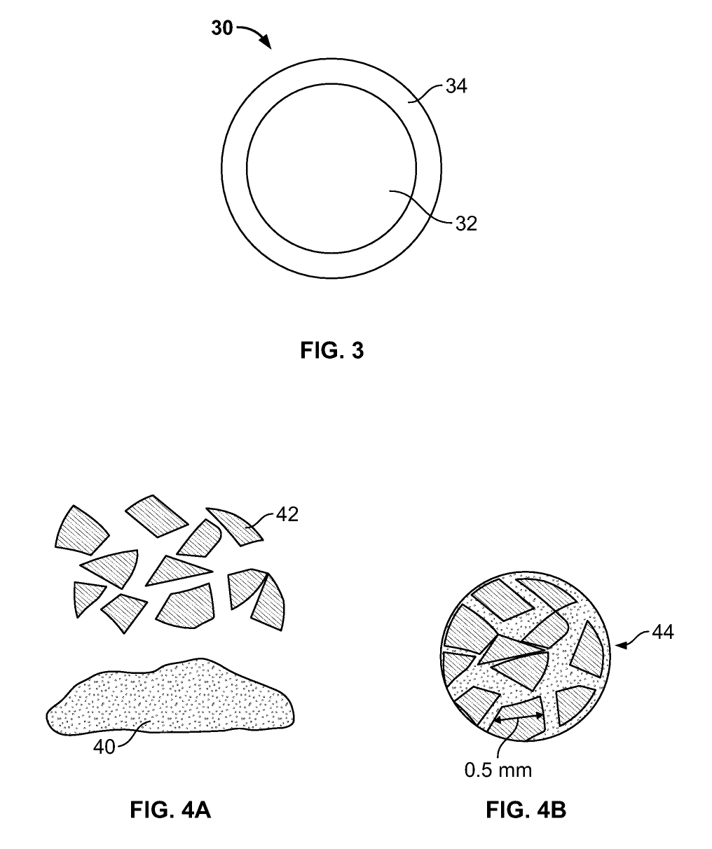

A plurality of agglomerated animal litter particles comprising a swelling core and clumping agent coating surface is described. Fibers as described above can be used as the cores. The core:coating ratio might range between 0.5 and 2. Referring to FIG. 3, the core 32 of the agglomerate particle 30 comprises primarily a swelling material (at least 60%) such as fibers preferably paper and or wood fibers, Na-bentonite, organic compounds like corn, rice, hay, straw, char etc. Core 32, with a particle size distribution that can range from 0.05 to 3 mm, might contain, in addition to swelling materials, a filling mineral and or a binder. The coating surface 34 comprises primarily a clumping bentonite, e.g., Na-bentonite. In addition, other minerals (e.g., kaolinite, zeolite etc . . . ), binders along with activated carbon and boron compounds and coloring agents can be added to the coating.

A plurality of light weight particles suitable for use as an animal litter comprising a core and a coating are formed. The coating process is intended to encapsulate granulated or particulated materials in order to improve the quality of the litter. The process can be any suitable process, however, processes already familiar to those of ordinary skill in the animal litter manufacturing art are particularly suitable.

In one embodiment, the core comprises at least 60% the composite particle and may include, fibers, Na-bentonite, hay, straw, corn, wood, rice, starch, super absorbent polymers, char etc. The coating is a Na-bentonite clay or other suitable clumping clay-based material, e.g., Ca-bentonite and a clumping agent. Optionally, activated carbon, boron compounds, binders, colorants and other minerals such as zeolite, kaolinite and Ca-carbonate might be added to the coating as well as to the core.

Benefits of this light weight composite particle include bulk density reduction (BDR), clump shape and strength, granules shape, attrition and particle size homogeneity. Specifically, the composite particles could provide from 30 to 60% BDR, which would drastically reduce shipping costs and make transportation of the litter product easier for consumers.

In addition, utilizing composite particles allows a more convenient way to incorporate other additives and provides a more homogeneous distribution of such additives (e.g., carbon and boron compounds). Thereby, maximizing the efficiency of the performance-enhancing actives' performance while minimizing the quantity of performance-enhancing active necessary.

### Conglomerated Ca/Na Bentonite

A two-part agglomerated clay particle is described: a granular light weight non-swelling material and a cementing/clumping agent such as Na-bentonite. The non-swelling particles (e.g., Ca-bentonite) are aggregated in the form of agglomerates by mixing with a clumping agent such as powdered Na-bentonite. The particle size distribution for the non-swelling granules ranges from about 25 to 40 mesh, whereas that of the cementing clumping agent ranges between about 200 to 325 mesh. Light weight granules would decrease the bulk density of the agglomerated particles while the Na-bentonite would give the particles a clumping behavior. The light weight granules serve as a skeleton to the newly formed composite particles while the clumping agent serves as cement. The amount of the non-swelling particles can range from 0 to 75%, while the clumping agent can vary from 20 to 80%. Optionally, a clumping agent such as starch, polyvinyl acetates, polyacrylates can be added to reinforce the cementing bentonite.

Sodium bentonite expands when wet and absorbs several times its dry weight in water. The property of swelling makes sodium bentonite an excellent clumping agent. On the other hand, Ca-bentonite is a non-swelling clay unless other additives or chemicals are added. The ionic surface of bentonite has a useful property in making a sticky coating on minerals (e.g., sand) or other hard grains. For example, when a small proportion of finely ground bentonite clay is added to hard sand particles and wetted, the clay binds these particles into a moldable aggregate known as “green sand” which is used for making molds in sand casting. Some river deltas naturally deposit “green sand”.

Referring to FIG. 4a, small cementing particles 40, e.g., Na-bentonite powder, can stick larger absorbent particles 42, e.g., Ca-bentonite, diatomites, lignite, shale, etc. to each other and generate a plurality of multi-particle agglomerates 44 (FIG. 4b) made up with several Ca-bentonite granules cemented to each other with Na-bentonite. Na-bentonite and Ca-bentonite have similar properties as they belong to the smectites group, plus the roughness of the Ca-bentonite provides a good substrate for Na-bentonite to stick to. It should be understood that present invention is not limited to Ca-bentonite but encompasses any material that can stick to the Na-bentonite and provide light weight liquid-absorbing particles, including kaolinite, volcanic ash, perlite, zeolite, silica gels, lignite, shale, diatomites and organic materials.

Pre-wetting of Ca-bentonite or other non-swelling absorbent material prior to blending with Na-bentonite would increase its volume and therefore decrease the density of the resulting composite particle even more.

In one embodiment, a pin mixer is used to agglomerate both the Ca-bentonite and Na-bentonite at the same time. This allows one or more performance—enhancing actives such as PAC and borax to be concentrated ate the on the surface of the resulting composite particle where they are expected to produce optimal odor control.

In another embodiment, a pin mixer is used to make a clay/paper-based litter. Recycled paper granules (50%) were coated with a mixture of bentonite powder (40-47%), kaolinite powder (2-5%), activated carbon (0-1%) and boric acid (0-1%). The bulk density ranges from about 0.60-0.70 g/cc, which is about a 30-40% reduction from traditional clay-based clumping animal litter. The mass of the coating is about one times the weight of the core.

In another embodiment, wood flour, e.g., that obtained form American Wood Fibers, Schofield, Wis., can be combined with the bentonite powder during the agglomeration. The wood flour would both lighten the particles and provide a natural means of ammonia control. Wood flour contains natural pine oil anti-microbials which help control ammonia. Wood flour is also a source of natural fragrance.

Without departing from the spirit and scope of this invention, one of ordinary skill can make various changes and modifications to the invention to adapt it to various usages and conditions. As such, these changes and modifications are properly, equitably, and intended to be, within the full range of equivalence of the following claims.

We claim:

1. A clumping animal litter comprising:
a plurality of composite particles comprising a mixture of (1) an absorbent material selected from the group consisting of sodium bentonite, calcium bentonite or combinations thereof; (2) at least one reinforcing fiber material, and (3) powder activated carbon;
wherein each composite particle contains 50-99.9% absorbent material, 0.1-50% reinforcing fiber material, and 0.1-20% powder activated carbon.

2. The clumping animal litter recited in claim 1, further comprising at least one performance-enhancing active selected from the group consisting of antimicrobials, odor absorbers/inhibitors, binding agents, fixing agents, fragrances, health indicating materials, nonstick release agents, filler materials and combinations thereof.

3. A plurality of composite particles suitable for use as an animal litter comprising:
a homogeneous mixture of (1) at least one absorbent material suitable for use as an animal litter and (2) at least one reinforcing fiber material, wherein each composite particle contains pores created through the use of a non-compaction agglomeration process, said non-compaction agglomeration process being capable of reducing the bulk density of the absorbent material by at least 10%; and
optionally at least one performance-enhancing active.

4. The plurality of composite particles recited in claim 3, wherein the absorbent material suitable for use as an animal litter is selected from the group consisting of swelling clays, non-swelling clays, absorbent rocks, natural minerals, synthetic minerals, straw, sawdust, wood chips, wood shavings, porous polymeric beads, shredded paper, bark, cloth, ground corn husks, cellulose, water-insoluble inorganic salts and combinations thereof.

5. The plurality of composite particles recited in claim 3, wherein the reinforcing fiber material is selected from the group consisting of wool, cotton, hemp, rayon, lyocell, paper, paper fluff, cellulose, bird feathers, carbon, activated carbon, polyester, nylon, plastics, polymers, copolymers, polymers charged with performance-enhancing actives and combinations thereof.

6. The plurality of composite particles recited in claim 3, wherein the performance-enhancing agent is selected from the group consisting of antimicrobials, odor absorbers, odor inhibitors, binding agents, fixing agents, fragrances, health indicating materials, nonstick release agents, superabsorbent materials, light-weighting minerals, filler materials and combinations thereof.

7. The plurality of composite particles recited in claim 3, wherein the composite particles comprise 50-99.9% absorbent material, 0.1-50% reinforcing fiber material, and 0-50% performance-enhancing active.

8. The plurality of composite particles recited in claim 3, wherein the reinforcing fiber materials are crimped.

9. The plurality of composite particles recited in claim 3, wherein the reinforcing fiber materials are multicomponent.

10. The plurality of composite particles recited in claim 3, wherein fractions of the reinforcing fiber materials protrude the surface of the composite particle.

11. The plurality of composite particles recited in claim 3, wherein the bulk density of the composite particles ranges from 18-36 lb/ft³.

12. The plurality of composite particles recited in claim 3, wherein clumps formed from wetting a portion of the composite particles with 10 ml of a 1N ammonium chloride solution or 10 ml of cat urine appear substantially similar in color to an unwetted portion of the composite particles.

13. The plurality of composite particles recited in claim 3, wherein the performance-enhancing active comprises a percentage of the composite particles.

14. The plurality of composite particles recited in claim 3, wherein the reinforcing fiber materials are porous.

15. The plurality of composite particles recited in claim 3, wherein the reinforcing fiber materials have a mean cylindrical shape and a length to diameter aspect ratio of at least 2 to 1.

16. The plurality of composite particles recited in claim 3, wherein the particle size of the reinforcing fiber materials is between 1 nm-5 mm.

17. The plurality of composite particles recited in claim 3, wherein the particle size of the composite particles are between 150 μm-5 mm.

18. The plurality of composite particles recited in claim 3, wherein the animal litter is capable of forming clumps upon wetting having an aspect ratio [square root of (the square of the longest clump length plus the square of the shortest clump length) divided by the clump height] ranging from 0.5 to 10.

19. The plurality of composite particles recited in claim 3, wherein the performance-enhancing active is activated carbon.

20. The plurality of composite particles recited in claim 3, wherein the homogeneous mixture further comprises (3) activated carbon.

21. The plurality of composite particles recited in claim 3, wherein at least one performance-enhancing active is embedded within the reinforcing fiber materials.

22. A method of forming the plurality of composite particles suitable for use as the plurality of composite particles recited in claim 3 comprising:
providing a plurality of absorbent materials suitable for use as an animal litter with particle sizes ranging from 1 nm-5 mm;
providing a plurality of reinforcing fiber materials with particle sizes ranging from 1 nm-5 mm;
providing powder activated carbon;
using a non-compaction agglomeration process to homogeneously agglomerate the absorbent materials, the reinforcing fiber materials and the activated carbon to form composite particles suitable for use as an animal litter ranging in particle size from 150 μm-5 mm, wherein each composite particle contains between 0.1%-19% reinforcing fiber material.
